(19) United States
(12) Patent Application Publication
(10) Pub. No.: US 2020/0070669 A1
(43) Pub. Date: Mar. 5, 2020

(54) SPEED ADJUSTMENT DEVICE FOR VEHICLES

(71) Applicant: Wen-Sung Lee, Taichung City (TW)

(72) Inventor: Wen-Sung Lee, Taichung City (TW)

(21) Appl. No.: 16/121,601

(22) Filed: Sep. 4, 2018

(51) Int. Cl. B60L 15/20; B60W 10/08

(52) U.S. Cl. CPC B60L 15/20; B60L 2240/12; B60L 2240/421; B60W 10/08

(57) ABSTRACT

A speed adjustment device for electric vehicles includes a motor, a battery, an acceleration detector, a control unit and a processing unit. The acceleration detector detects the speed of the electric vehicle every period of time which is less than 0.5 seconds, and the acceleration detector generates an acceleration value which is sent to the control unit, and the processing unit calculates the acceleration value and generates a current speed value. The control unit compares the current speed value and the preset constant speed value to control output of the motor and output of the battery.

### BACKGROUND OF THE INVENTION

### 1. Fields of the Invention

The present invention relates to a speed adjustment device, and more particularly, to a speed adjustment device for electric vehicles.

### 2. Descriptions of Related Art

The conventional speed adjustment device for electric vehicles includes a speed detector for detecting the speed that the vehicle moves, and a control unit is electrically connected to the motor and the battery. The speed detector detects the speed of the vehicle and sends the speed value to the control unit so that the control unit compares the speed value with the pre-set constant speed that has set in the control unit. According to the comparison, the control unit increases or reduces the output force of the motor and the battery.

For a motorbike with the tires having diameter of 70 cm, assume that the pre-set constant speed is 20 km/hr, when the speed of the motorbike reduces from 20 km/hr to 18 km/hr, and therefore increases the output of the motor and the battery. Because the speed detector detects the speed of the motorbike after the wheel rotates at least one revolution, in this example, the wheel rotates two revolutions. The travel length that the wheel rotates two revolutions is L=2×π×D≅4.40 m. The average speed when reducing the speed is v=(2(20 +18)/2 (“km/hr)”≅5.28 m/s. The time required that the control unit confirms the speed reduction is Δt=L/v=4.40/5.28≅0.83 sec. The pre-set constant speed is v0=20(km/hr)≅5.55 m/s. The reduced speed is v1=18 (km/hr)=5.00 m/s.

As shown in FIG. 7, assume that the sum of the total weight of the rider 40 and the motorbike 50 is 90 kg. The energy that the motorbike increases its speed from 18 km/hr to 20 km/hr is

∇Eₖ₁=1/2mv₀²−1/2mv₁²≅1/2×(90)×(5.55)²−1/2×(90)×(5.00)²≅263.89 (J)

It is noted that when the control unit confirms the speed change, it requires a certain period of time due to the requirement of two revolutions of the wheel moves. In other words, the motorbike moves from point A to point B to reduce the speed to 18 km/hr, at this point, the control unit increases the output of the motor and the battery. However, the detector still require a period of time to confirm that the speed reaches 20 km/hr, and the vehicle actually has moved to point C where the speed of the motorbike could be 25 km/hr.

Furthermore, as shown in FIG. 6 which shows the power model that the detector sends the speed value to the control unit every 0.5 second. The bold lines represent the speed of the motorbike, and the thin lines represent the current. As analysis above, because the speed detector detects the speed of the motorbike requires a period of time and makes the detected speed is not the current or actual speed of the motorbike when the, control unit receives the data, this may cause overly acceleration as disclosed in the areas represented by inclined lines. These areas are high power consuming areas and consume more electric energy, and the speed of the motorbike cannot maintain a smooth and constant movement.

The present invention is intended to provide a speed adjustment device for electric vehicles, and is designed to eliminate the drawbacks mentioned above.

### SUMMARY OF THE INVENTION

The present invention relates to a speed adjustment device for electric vehicles, and comprises a motor and a battery for providing electric power to the motor, and an acceleration detector. The acceleration detector detects the speed of the electric vehicle every period of time which is less than 0.5 seconds, and the acceleration detector generates an acceleration value which is sent to a control unit that is electrically connected to the motor, the battery and the acceleration detector. The control unit has a preset constant speed value and a processing unit. The processing unit calculates the acceleration value and generates a current speed value. The control unit compares the current speed value and the preset constant speed value to output an adjustment signal to control output of the motor and output of the battery.

When the current speed value is larger than the preset constant speed value, the control unit reduces the output of the motor and the output of the battery. When the current speed value is smaller than the preset constant speed value, the control unit increases the output of the motor and the output of the battery.

Preferably, the control unit is electrically connected with a display unit which displays the current speed value that is generated as the processing unit calculates the acceleration value.

Preferably, the control unit is electrically connected with a constant speed setting button. The control unit replaces the preset constant speed value with the current speed value that is generated as the processing unit calculates the acceleration value.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that the speed adjustment device for electric vehicles of the present invention is installed to a motorbike;

FIG. 2 shows that the speed is displayed on the display unit;

FIG. 3 illustrates the components of the speed adjustment device for electric vehicles of the present invention;

FIG. 4 shows the different speeds of the motorbike with the speed adjustment device for electric vehicles of the present invention;

FIG. 5 shows the electric energy consumption of the speed adjustment device for electric vehicles of the present invention;

FIG. 6 shows the electric energy consumption of a conventional speed detector used on electric vehicles;

FIG. 7 shows the different speeds of the motorbike with the conventional speed detector.

### DETAILED DESCRIPTION OF THE PREFERRED EMBODIMENT

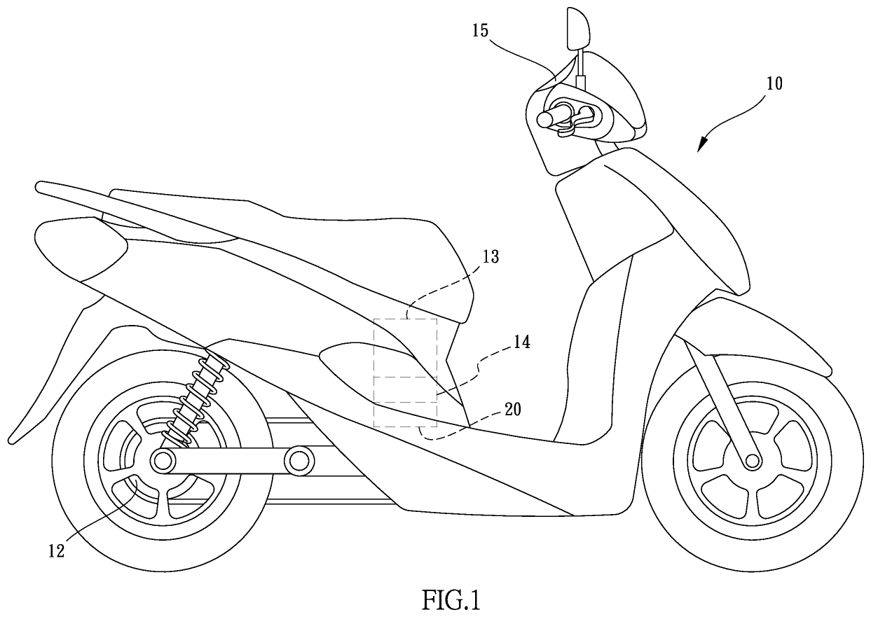

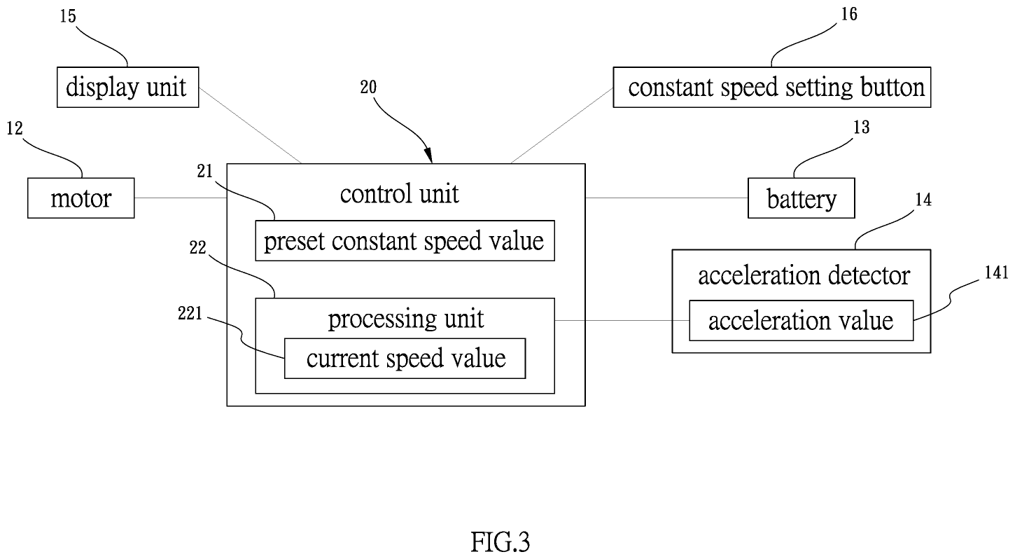

Referring to FIGS. 1 to 3, the speed adjustment device for electric vehicles of the present invention comprises a motor 12 and a battery 13 for providing electric power to the motor 12, and an acceleration detector 14. The acceleration detector 14 is installed to the electric vehicle 10 such as an electric motorbike, and detects the speed of the electric vehicle 10 every period of time which is less than 0.5 second, and the acceleration detector 14 generates an acceleration value 141 accordingly.

A control unit 20 is installed to the electric vehicle 10 and electrically connected to the motor 12, the battery 13 and the acceleration detector 14. The control unit 20 has a preset constant speed value 21 and a processing unit 22. The control unit 20 receives the acceleration value 141 from the acceleration detector 14, and the processing unit 22 calculates the acceleration value 141 and generates a current speed value 221. The control unit 20 compares the current speed value 221 and the preset constant speed value 21 to output an adjustment signal to control the output of the motor 12 and the output of the battery 13.

When the current speed value 221 is larger than the preset constant speed value 21, the control unit 20 reduces the output of the motor 12 and the output of the battery 13. Alternatively, when the current speed value 221 is smaller than the preset constant speed value 21, the control unit 20 increases the output of the motor 12 and the output of the battery 13.

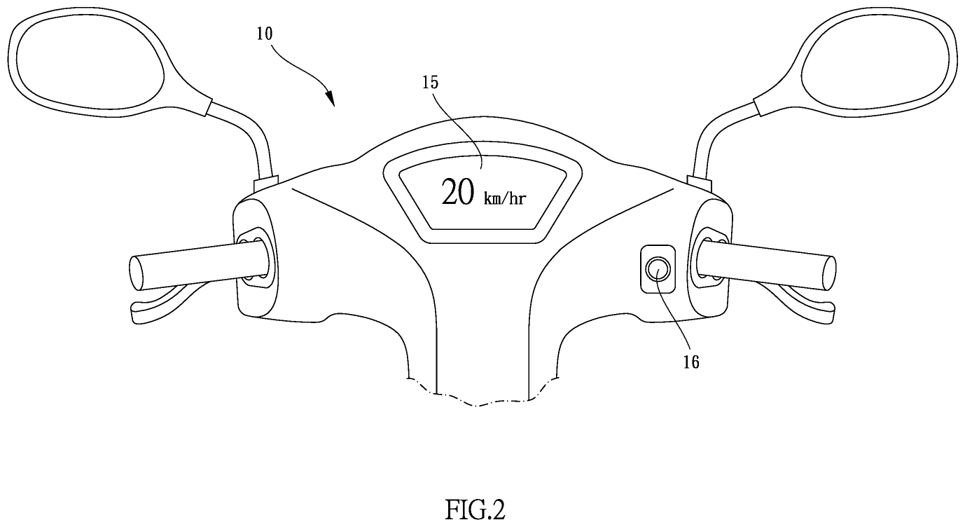

Specifically, the control unit 20 is electrically connected with a display unit 15, and the display unit 15 displays the current speed value 221 that is generated as the processing unit 22 calculates the acceleration value 141 as shown in FIG. 2. Furthermore, the control unit 20 is electrically connected with a constant speed setting button 16. The control unit 20 replaces the preset constant speed value 21 with the current speed value 221 that is generated as the processing unit 22 calculates the acceleration value 141, if the user presses the constant speed setting button 16 during operation of the electric vehicle 10.

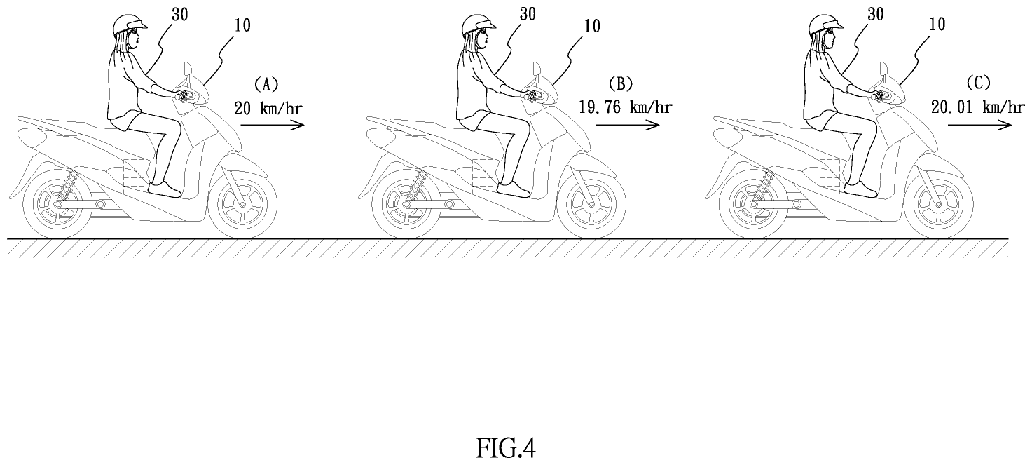

The acceleration detector 14 detects the speed of the electric vehicle 10 every period of time which is less than 0.5 seconds which is much less than the time required of 0.83 seconds of the conventional speed detector. Therefore, the efficiency for controlling the speed of the electric vehicle 10 can be increased. Assume that the preset constant speed value 21 is 20 km/hr, the present invention is able to confirm the speed of the electric vehicle 10 when the speed of the electric vehicle 10 reduces to 19.76 km/hr. As shown in FIG. 4, when the electric vehicle 10 moves from point A to point B, and is confirmed that the speed is reduced, the control unit 20 then increases the output of the motor 12 and the output of the battery 13. The 19.76 km/hr≅5.49 m/s. Assume that the total weight of the electric vehicle 10 and the rider is 90 kg. The energy consumed during the period of the speed of 19.76 km/hr to the preset constant speed value 21 (20 km/hr) will be:

∇Eₖ₂=1/2mv₀²−1/2mv₂²≅1/2×(90)×(5.55)²−1/2×(90)×(5.49)²≅33.13(J)

Therefore, when the current speed value 221 is smaller than the preset constant speed value 21 (20 km/hr), the control unit 20 increases the output of the motor 12 and the output of the battery 13. The ratio of the enemy consumption for the speed of the electric vehicle 10 from 19.76 km/hr to 20 km/hr relative to that of the electric vehicle using the convention speed detector is:

Ratio=(∇E_k2)/(∇E_k1)≅(33.13)/(263.89)≅0.1256=12.56%

That is to say, the energy consumption that the electric vehicle 10 using the present invention consumes is 12.56% of that using the conventional speed detector. And the speed of the electric vehicle 10 can quickly and electively reach the desired speed to avoid energy loss. As shown in FIG. 4, when the electric vehicle 10 moves to point C, the speed of the electric vehicle 10 reaches 20.01 km/hr which is higher than the preset constant speed value 21 (20 km/hr), the control unit 20 reduces the output of the motor 12 and the output of the battery 13.

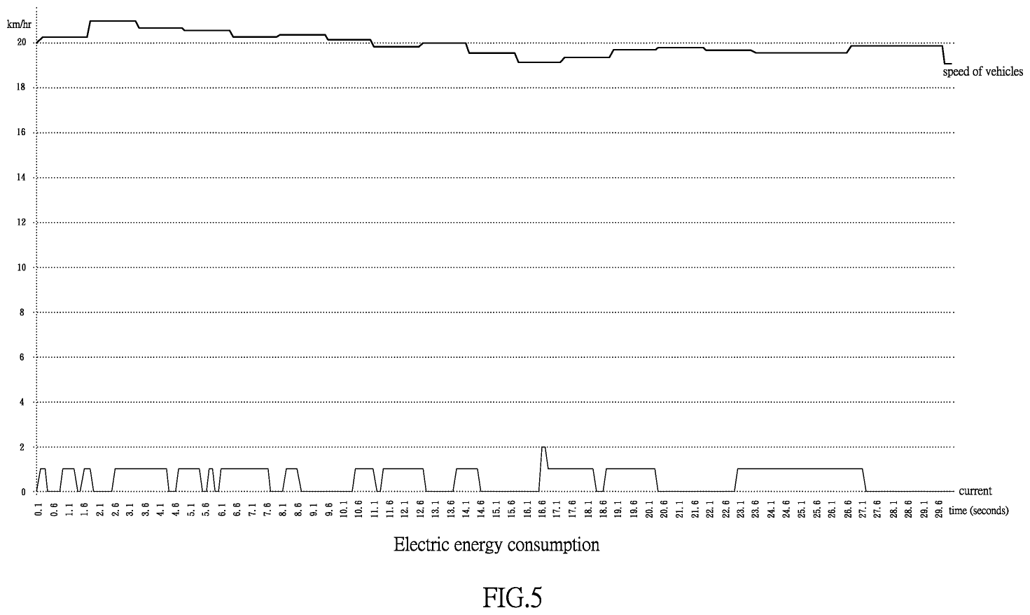

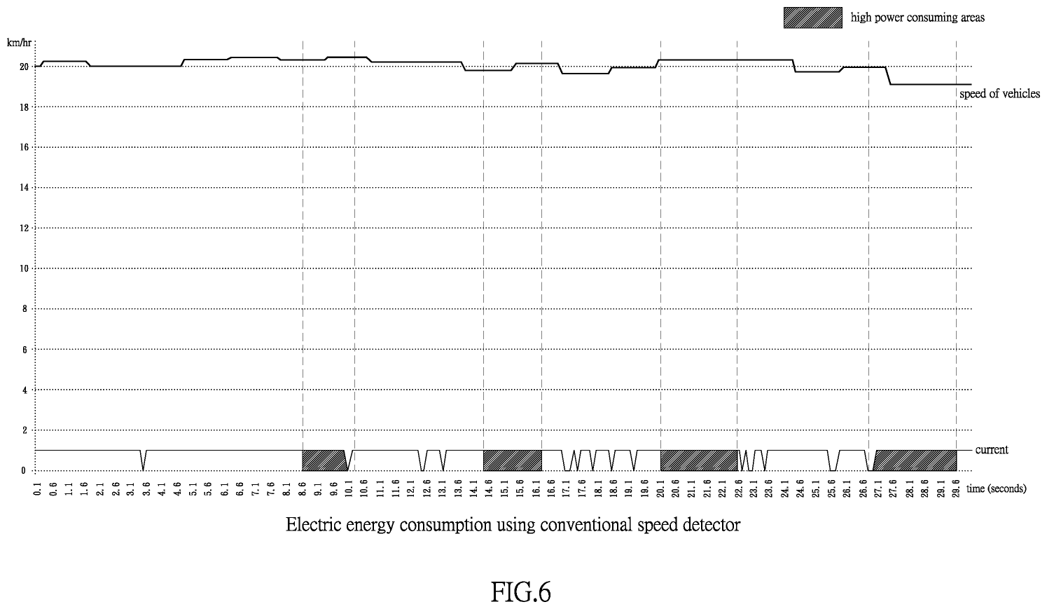

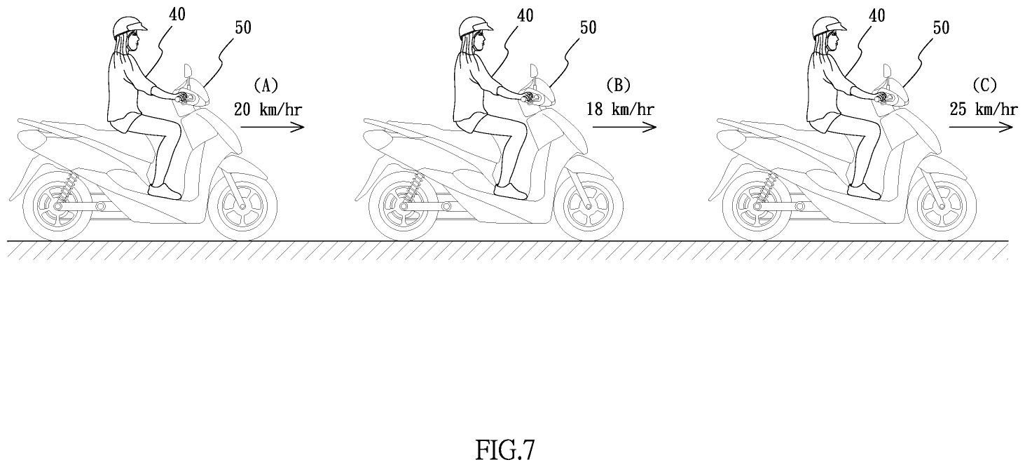

As shown in FIG. 5, the bold lines represent the speed or the motorbike, and the thin lines represent the current. The Y-axis shows the speed of the electric vehicle 10, and the X-axis shows the seconds between adjacent two detections. The acceleration detector 14 detects the speed of the electric vehicle 10 by less than 0.5 second interval and the electric vehicle 10 moves at constant speed. Whenever the speed of the electric vehicle 10 is higher or lower than the preset constant speed value 21 (20 km/hr), the motor 12 and the battery 13 are adjusted by the control unit 20 to match the preset constant speed value 21. Comparing FIG. 5 and FIG. 7. the speed of the electric vehicle 10 using the speed adjustment device can instantly catch up the preset constant speed value 21 (20 km/hr). Therefore the energy can be saved as disclosed in FIG. 6.

While we have shown and described the embodiment in accordance with the present invention, it should be clear to those skilled the art that further embodiments may be made without departing from the scope of the present invention.

What is claimed is:

1. A speed adjustment device for electric vehicles, comprising:
a motor and a battery for providing electric power to the motor, and an acceleration detector;
the acceleration detector configured to detect speed of the electric vehicle in every period of time which is less than 0.5 seconds, and the acceleration detector generating an acceleration value, and
a control, unit electrically connected to the motor, the battery and the acceleration detector, the control unit having a preset constant speed value and a processing unit, the control unit receiving the acceleration value from the acceleration detector, the processing unit calculating the acceleration value and generating a current speed value, the control unit comparing the current speed value and the preset constant speed value to output an adjustment signal to control output of the motor and output of the battery, when the current speed value is larger than the preset constant speed value, the control unit reduces the output of the motor and the output of the battery, when the current speed value is smaller than the preset constant speed value, the control unit increases the output of the motor and the output of the battery.

2. The speed adjustment device tor electric vehicles as claimed in claim 1, wherein the control unit is electrically connected with a display unit, the display unit displays the current speed value that is generated as the processing unit calculates the acceleration value.

3. The speed adjustment device for electric vehicles as claimed in claim 1, wherein the control unit is electrically connected with a constant speed setting button, the control unit replaces the preset constant speed value with the current speed value that is generated as the processing unit calculates the acceleration value.
